(19) United States
(12) Patent Application Publication
(10) Pub. No.: US 2025/0185649 A1
(43) Pub. Date: Jun. 12, 2025

(54) AGRICULTURAL CHEMICAL FORMULATION

(71) Applicant: ExxonMobil Chemical Patents Inc., Baytown, TX (US)

(72) Inventors: Nan Hu, Houston, TX (US); Maria Milina, Glen Ridge, NJ (US); Aaron Eberle, Spring, TX (US); Chunzhao Li, Spring, TX (US); Virginia Vance, Seabrook, TX (US); Daniel Bien, Remagen (DE)

(21) Appl. No.: 18/836,240

(22) PCT Filed: Feb. 13, 2023
(86) PCT No.: PCT/EP2023/053538

§ 371 Date: Aug. 6, 2024

Related U.S. Application Data
(60) Provisional application No. 63/267,954, filed on Feb. 14, 2022.

(30) Foreign Application Priority Data
Mar. 17, 2022 (EP) 22162822.5

(51) Int. Cl. A01N 25/02; A01N 25/04; A01N 33/08; A01P 13/00

(52) U.S. Cl. CPC A01N 25/02; A01N 25/04; A01N 33/08; A01P 13/00

(57) ABSTRACT

Provided herein is an agrochemical composition suitable for use as an emulsifiable concentrate, comprising one or more active ingredients; one or more alkylated aromatic solvents, and optionally, one or more surfactants.

### FIELD OF THE INVENTION

The present disclosure relates to agricultural chemical compositions, uses thereof, and methods for protecting crops.

### BACKGROUND OF THE INVENTION

Agrochemical compositions are often provided as mixtures or blends of solvent, one or more active ingredients (such as insecticides, herbicides, fungicides, and nematicides), and one or more other components such as surfactants, promoters, and adjuvants. Often, such chemicals are distributed in liquid emulsifiable concentrates which can be blended with water at the treatment site to produce an emulsion that is distributed over crops and/or pests, typically by spraying.

It is desirable that the solvent used in such concentrate has a high solvency for the one or more active ingredients, a low solubility in water, and low toxicity. There remains a need for solvents providing a good balance of solvency, water solubility, and toxicity.

### SUMMARY OF THE INVENTION

It is an object of the present application to provide agrochemical compositions comprising one or more active ingredients, one or more solvents, and optionally one or more surfactants. The agrochemical compositions described herein may be used as an emulsifiable concentrate, which may be blended with water to form an emulsion.

In particular, provided herein is an agrochemical composition comprising:
one or more active ingredients;
an aromatic solvent comprising at least 50 wt % of one or more compounds selected from compounds of formula (A) and (B):

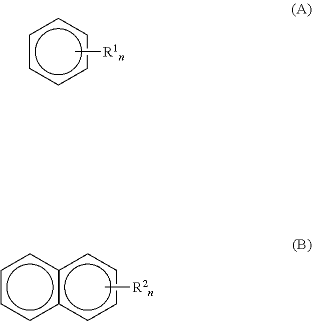

wherein n is an integer ranging from 2 to 5; and m is an integer ranging from 1 to 5;
each R¹ and each R² is independently a linear or branched C₁-C₁₆alkyl; provided that in compounds of formula (A) at least one R¹ is C₄-C₁₆alkyl; and in compounds of formula (B) at least one R² is C₄-C₁₆alkyl;
and
optionally, one or more surfactants.

Further provided herein is an emulsion comprising said agrochemical composition and water.

The present inventors have found that the solvents used in these formulations allow for effectively dissolving a variety of agriculturally active ingredients such as herbicides, while have a low solubility in water. These solvents can provide an improved and/or potentially less toxic solvent alternative for known emulsifiable concentrates.

The independent and dependent claims set out particular and preferred features of the invention. Features from the dependent claims may be combined with features of the independent or other dependent claims, and/or with features set out in the description above and/or hereinafter as appropriate.

The above and other characteristics, features and advantages of the present invention will become apparent from the following detailed description which illustrates, by way of example, the principles of the invention. This description is given for the sake of example only, without limiting the scope of the invention.

### DETAILED DESCRIPTION OF THE INVENTION

The present invention will be described with respect to particular embodiments.

It is to be noticed that the term “comprising”, used in the claims, should not be interpreted as being restricted to the means listed thereafter; it does not exclude other elements or steps. It is thus to be interpreted as specifying the presence of the stated features, steps or components as referred to, but does not preclude the presence or addition of one or more other features, steps or components, or groups thereof. Thus, the scope of the expression “a device comprising means A and B” should not be limited to devices consisting only of components A and B. It means that with respect to the present invention, the only relevant components of the device are A and B.

Throughout this specification, reference to “one embodiment” or “an embodiment” are made. Such references indicate that a particular feature, described in relation to the embodiment is included in at least one embodiment of the present invention. Thus, appearances of the phrases “in one embodiment” or “in an embodiment” in various places throughout this specification are not necessarily all referring to the same embodiment, though they could. Furthermore, the particular features or characteristics may be combined in any suitable manner in one or more embodiments, as would be apparent to one of ordinary skill in the art.

All numerical values within the detailed description herein are modified by “about” the indicated value, and take into account experimental error and variations that would be expected by a person having ordinary skill in the art.

The following terms are provided solely to aid in the understanding of the invention.

The term “alkene” or “olefin” as used herein refers to a hydrocarbon containing a carbon-carbon double bond. Alkenes/olefins may be linear or branched, unless specified otherwise.

The term “alkyl” or “alkyl group” as used herein interchangeably refers to a saturated hydrocarbyl group consisting of carbon and hydrogen atoms. An alkyl group can be linear or branched, and does not include ring structures, unless specifically mentioned otherwise.

The term “aryl” or “aryl group” as used herein interchangeably refers to a hydrocarbyl group comprising an aromatic ring structure therein.

The prefix “Cₓ” or “C_{y}-C_{z}” before the term “alkene”, “alkyl”, or “aryl”, indicates in each case the total number of carbon atoms of the respective radical or molecule. For example, “C₄alkyl” refers to an alkyl groups having 4 carbon atoms, “C₁₋C₄alkyl” refers to alkyl groups having 1 to 4 carbon atoms, and “C₄₊alkyl” refers to alkyl groups having 4 or more carbon atoms.

Provided herein are compositions suitable for use in agriculture, which contain one or more active ingredients such as pesticides. The one or more active ingredients are dissolved or suspended, preferably dissolved, in a solvent or mixture of solvents. The compositions described herein may be used as an emulsifiable concentrate, and may be blended with water to form an emulsion which can be distributed over crops or weeds, e.g. via spraying. A surfactant may be present in the composition to facilitate the preparation of the emulsion and/or to improve emulsion stability.

More particularly, provided herein is an agrochemical composition (also referred to herein as “the composition” or “the compositions”), comprising:
one or more active ingredients;
an aromatic solvent comprising at least 50 wt % of one or more compounds selected from compounds of formula (A) and (B):

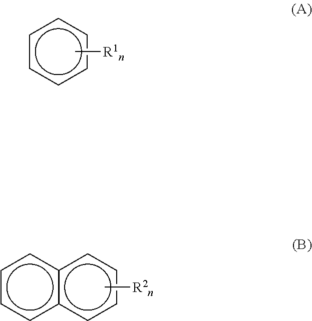

wherein n is an integer ranging from 2 to 5; and m is an integer ranging from 1 to 5; each R¹ and each R² is independently a linear or branched C₁-C₁₆alkyl; provided that in compounds of formula (A) at least one R¹ is C₄-C₁₆alkyl; and in compounds of formula (B) at least one R² is C₄-C₁₆alkyl;
   and
optionally, one or more surfactants.

A compound of formula (A) wherein n is an integer ranging from 2 to 5; each R¹ is independently a linear or branched C₁-C₁₆alkyl, wherein at least one R¹ is C₄-C₁₆alkyl; is further referred to herein as “Compound (A)”. References to “Compound (A)” may include mixtures of two or more of such compounds, unless specified otherwise. Likewise, a compound of formula (B) wherein m is an integer ranging from 1 to 5; each R² is independently a linear or branched C₁-C₁₆alkyl, wherein at least one R² is C₄-C₁₆alkyl; is further referred to herein as “Compound (B)”. References to “Compound (B)” may include mixtures of two or more of such compounds, unless specified otherwise. The skilled person will understand that in Compound (B), the one or more R² groups may appear on either ring of the naphthalene structure. More particularly, each of the rings may carry one or more R² substituents.

As described above, the compositions described herein comprise an aromatic solvent (also referred to herein as “the aromatic solvent”) comprising at least 50 wt % of any combination of Compound (A) and Compound (B). The aromatic solvent may comprise one or more compounds of formula (A) as defined above; one or more compounds of formula (B) as defined above; or mixtures thereof. More particularly, the aromatic solvent may comprise a single aromatic solvent compound of formula (A) or (B); or a blend of two or more of such solvent compounds, provided that the total amount of Compound (A) and Compound (B) in the aromatic solvent is at least 50 wt %. In particular embodiments, the total amount of Compound (A) and Compound (B) in the aromatic solvent may be at least 60 wt %, at least 70 wt %, or at least 75 wt %.

In preferred embodiments, the aromatic solvent may comprise a higher amount (in wt %) of Compound (B) than of Compound (A). Nevertheless, the presence of at least some Compound (A) may still be desirable to improve solubility of certain active ingredients. In particular embodiments, the aromatic solvent may comprise at least 50 wt % of Compound (B), and optionally at least 5 wt % of Compound (A). Additionally or alternatively, the weight ratio of Compound (B) to Compound (A) may be at least 5:1, or at least 10:1.

In particular embodiments, in Compound (A) and Compound (B), each R¹ and R² may be independently a linear or branched C₁-Cₓalkyl, wherein x is an integer from 6 to 12; provided that in Compound (A) at least one R¹ is C₄-Cₓalkyl; and in Compound (B) at least one R² is C₄-Cₓalkyl. In further embodiments, x may be 10, 8, or 6. In certain embodiments, x may be 4, i.e. R¹ and R² are C₁-C₄alkyl, wherein at least one R¹ in Compound (A) and at least one R² in Compound (B) is butyl. While at least one R¹ and R² is C₄-Cₓalkyl, it is preferred that most of Compound (A) and Compound (B) only contain one or two C₄₊alkyl substituents (i.e. alkyl substituents having 4 or more carbon atoms), as increasing the amount of C₄₊alkyl substituents can increase the solvent viscosity. In particular embodiments, no more than 15 wt %, for example 5 wt % to 15 wt %, of the aromatic solvent consists of compounds selected from: (a) Compound (A) wherein at least two R¹ groups have at least 4 carbon atoms; and (b) Compound (B) wherein at least two R² groups have at least 4 carbon atoms.

Also the amount of R¹ and R² substituents can influence the solvent viscosity. In preferred embodiments, n ranges from 1 to 4 and m ranges from 2 to 4.

In particular embodiments, the R¹ and R² substituents which are C₄₊alkyl may all have the same number of carbon atoms, e.g. they may all be butyl. However, it is not excluded that in some embodiments, different C₄₊alkyl groups may be present, e.g. butyl and hexyl.

The aromatic solvent may further contain other components in addition to Compound (A) and/or Compound (B). Such other components, if present, will typically also be mainly aromatic. Examples of such other components include compounds of formula (C) or formula (D):

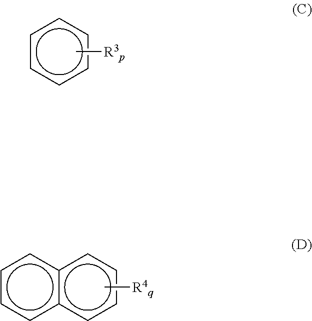

wherein p and q independently are an integer ranging from 0 to 5;
R³ is a linear or branched C₁-C₁₆alkyl if p is 1, and each R³ is independently a C₁-C₃alkyl if
p is 2 to 5; and
each R⁴ is independently a C₁-C₃alkyl.

A compound of formula (C) wherein p is an integer ranging from 0 to 5; each R³ is independently a C₁-C₃alkyl if p is 2 to 5, and R³ is C₁-C₁₆alkyl if p is 1; is further referred to herein as “Compound (C)”. References to “Compound (C)” include mixtures of two or more of such compounds, unless specified otherwise. Likewise, a compound of formula (D) wherein q is an integer ranging from 0 to 5; and each R⁴ is independently a C₁-C₃alkyl; is further referred to herein as “Compound (D)”. References to “Compound (D)” include mixtures of two or more of such compounds, unless specified otherwise. The skilled person will understand that in Compound (D), the one or more R⁴ groups may appear on either ring of the naphthalene structure. More particularly, each of the rings may carry one or more R⁴ substituents.

Preferably, p and q independently are an integer ranging from 1 to 5. In such and other embodiments, the aromatic solvent preferably contains less than 1 wt % benzene, and less than 1 wt % of naphthalene. In further embodiments, the total content of benzene and naphthalene in the aromatic solvent may be less than 1 wt %.

In preferred embodiments, the total aromatic content of the aromatic solvent may be at least 90 wt %, at least 95 wt %, or even at least 99 wt %. The total aromatic content, as well as the content of compounds of formula (A)-(D), can be determined via Gas Chromatography-Mass Spectrometry (GC-MS), for example according to ASTM D5769.

In particular embodiments, the aromatic solvent contains at least 90 wt %, or at least 95 wt %, of compounds selected from Compound (A), Compound (B), Compound (C), and Compound (D); provided that the aromatic solvent further contains the required amount of compounds selected from Compound (A) and Compound (B) as set out above.

As indicated above, in some embodiments, the aromatic solvent may comprise a higher amount of Compound (B) than Compound (A). In such and other embodiments, the aromatic solvent may also comprise a higher amount of Compound (D) than Compound (C). In particular embodiments, the aromatic solvent may comprise at least 75 wt % of compounds selected from Compound (B) and Compound (D).

In addition to the aromatic solvent, the composition may comprise one or more other solvents, also referred to herein as “co-solvent” or “co-solvents”. Co-solvents suitable in the compositions described herein may include solvents which are commonly used in emulsifiable concentrates for use in agriculture, such as alkyl benzoates and amides. The one or more co-solvents typically form less than 50 wt % of the total solvent content of the composition, or less than 40 wt %, less than 30 wt %, less than 20 wt %, or even less than 10 wt %.

Accordingly, typically at least 50 wt % of the total solvent content in the composition consists of the aromatic solvent as described above, or at least 60 wt %, at least 70 wt %, at least 80 wt %, or at least 90 wt %. In some embodiments, the solvent in the composition consists entirely of the aromatic solvent. Additionally or alternatively, it is preferred that at least 25 wt % of the total solvent content in the composition consists of compounds selected from Compound (A) and Compound (B). In further embodiments, at least 30 wt %, at least 40 wt %, or at least 50 wt % of the total solvent content in the composition may consist of compounds selected from Compound (A) and Compound (B).

The aromatic solvent may be prepared via an alkylation reaction of an aromatic solvent comprising monocyclic and/or bicyclic aromatic compounds. The alkylation reaction will typically involve contacting such aromatic solvent with an alkene, generally in the presence of a catalyst, under conditions suitable for alkylation of the aromatic solvent molecules. Suitable catalysts and reaction conditions are well known in the art. Examples of suitable catalysts include, but are not limited to ultra-stable Y zeolite (USY) as described in patent application publication WO 2006/047054, acidic clays as described in U.S. Pat. No. 4,714,794, or zeolites such as ZSM-20 or ZSM-30 zeolites as described in U.S. Pat. No. 4,301,316.

In particular embodiments, the aromatic solvent present in the compositions is obtainable via an alkylation reaction involving contacting one or more C₄₋₁₂olefins with an aromatic solvent comprising at least 50 wt % (preferably at least 75, or at least 90 wt %) of one or more compounds of formula (E) and/or (F):

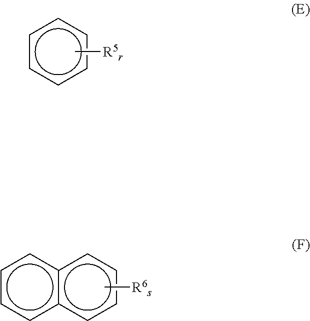

wherein r and s independently are an integer ranging from 0 to 4, preferably 0 to 3, or 0 to 2; R⁵ can be a linear or branched C₁-C₁₆alkyl if r is 1, and each R⁵ is independently C₁-C₃alkyl if r is 2 or more; and
each R⁶ is independently C₁-C₃alkyl, preferably methyl or ethyl;

in the presence of a catalyst, under conditions suitable for alkylating the aromatic solvent. The degree of alkylation may be controlled via reaction parameters such as the reaction time and temperature. Additionally or alternatively, unreacted solvent molecules may be removed at least partially via distillation, to increase the concentration of Compound (A) and/or Compound (B) in the final product.

The C₄₋₁₂olefins may comprise alpha-olefins, but may also comprise internal olefins.

The skilled person will understand that the choice of C₄₋₁₂olefins used in the alkylation reaction will affect the type of C₄₊alkyl R¹ and R² group(s) which can be found in Compound (A) and Compound (B). For example, alkylation with butenes will result in the addition of R¹ and R² groups which are butyl. In particular embodiments, the one or more olefins may be C₄₋₁₀olefin, C₄₋₈olefin, or C₄₋₆olefin.

In particular embodiments, the aromatic solvent may comprise at least 50 wt % of C₁₄₊ hydrocarbons (i.e. hydrocarbon compounds having at least 14 carbon atoms), preferably at least 60 wt %, or at least 75 wt %. Additionally or alternatively, the aromatic solvent may comprise at least 50 wt % of C₁₅₊ hydrocarbons (i.e. hydrocarbon compounds having at least 15 carbon atoms). Preferably, the aromatic solvent comprises less than 2 wt % of C₂₈₊ hydrocarbons (i.e. hydrocarbon compounds having at least 28 carbon atoms), more preferably less than 1 wt %. The amount of hydrocarbons having a certain carbon number can be determined via GC-MS.

In preferred embodiments, the aromatic solvent has a low content of naphthalene, 1-methylnaphthalene, and/or 2-methylnaphthalene. In particular embodiments, the aromatic solvent comprises a total amount of naphthalene, 1-methylnaphthalene, and/or 2-methylnaphthalene of less than 3 wt %, less than 2 wt %, or less than 1 wt %. Additionally or alternatively, the aromatic solvent may comprise less than 1 wt % of naphthalene. The aromatic solvent may further comprise less than 1 wt % benzene. The amount of benzene, naphthalene, 1-methylnaphthalene, and/or 2-methylnaphthalene can be determined according to ASTM D5769.

In preferred embodiments, the aromatic solvent has a low sulfur content. For example, the aromatic solvent may comprise less than 10 wppm (weight parts per million) sulfur as determined according to ASTM D5453.

The aromatic solvent typically is insoluble in water. In particular embodiments, the aromatic solvent has a solubility in water below 0.1 wt % (at 20° C.). Additionally or alternatively, the solubility of water in the aromatic solvent may be below 0.1 wt % (at 20° C.). The solvent solubility in water and water solubility in solvent can be determined as follows: 20 grams of tested solvent is mixed with 20 grams of water, the mixture is stirred for 2 hours and then transferred to a separating funnel. The funnel containing the mixture is inverted several times. The water and solvent phases are allowed to separate for 24 hours, resulting in two distinct phases. For solvent solubility in water, the water layer is transferred to a sample vial and tested by a gas chromatography test method for solvent content. For water solubility in solvent, the solvent layer is transferred to a sample vial and tested for water content according to ASTM E1064.

In particular embodiments, the aromatic solvent has one or more of the following properties:
a kinematic viscosity at 25° C. between 5 mm²/s and 25 mm²/s as measured according to ASTM D7042;
a density ranging from 0.95 to 1.00, as measured at 25° C. according to ISO 12185;
a pour point below −40° C., as measured according to ASTM D5950;
a naphthalene content below 1.0 wt % as measured according to ASTM D5769; and
a total 1-methylnaphthalene and 2-methylnaphthalene content below 10 wt % as measured according to ASTM D5769.

As described above the kinematic viscosity increases with the amount of R¹ or R² substituents which are C₄₊alkyl. As can be seen from the examples (see further), the alkylation of an aromatic solvent with C₄₊alkyl also allows for decreasing the pour point.

The compositions described herein comprise one or more active ingredients useful in agriculture, also known as “agrochemicals” or “agrichemicals”. The one or more active ingredients typically include at least one pesticide or substance for pest control. Examples of pesticides include, but are not limited to, herbicides, insecticides, fungicides, acaricides, nematicides, miticides, rodenticides, bactericides, molluscicides, bird repellents, and combinations thereof.

The one or more active ingredients are typically organic compounds, i.e. chemical compounds that contain carbon-hydrogen bonds. More particularly, the one or more active ingredients preferably are organic pesticides.

In particular embodiments, the one or more active ingredients contain at least one herbicide. Non-limitative examples of suitable herbicides include dinitroaniline herbicides, synthetic auxins, nitrile herbicides, aminopyridine herbicides, triazolinone herbicides, amide herbicides, chloroacetanilide herbicides, quinolone herbicides, thiophene herbicides, pyrimidinedione herbicides, triazine herbicides, and derivatives (e.g. esters or salts) thereof. Esters derivatives may be formed if the herbicide contains a carboxyl group (the ester then being the condensation product of the herbicide and an alcohol, preferably an alcohol having 1 to 10 carbon atoms) or hydroxyl group (the ester then being the condensation product of the herbicide and a carboxylic acid, preferably a carboxylic acid having 1 to 10 carbon atoms).

In particular embodiments, the one or more active ingredients contain one or more herbicides selected from dinitroaniline herbicides, synthetic auxins, nitrile herbicides, and derivatives (e.g. esters or salts) thereof. In further embodiments, the one or more active ingredients contain one or more herbicides selected from dinitroaniline type herbicides, pyridine-carboxylic acid synthetic auxins, nitrile herbicides, and derivatives (e.g. esters or salts) thereof.

Examples of dinitroaniline herbicides include trifluralin, benfluralin, butralin, ethalfluralin, dinitramine, oryzalin, and pendimethalin.

Examples of synthetic auxins include pyridine-carboxylic acids (such as fluroxypyr, aminopyralid, clopyralid, picloram, and triclopyr), benzoic acids (such as chloramben, dicamba, and 2,3,6-trichlorobenzoic acid or TBA), phenoxy-carboxylic acids (such as 2-methyl-4-chlorophenoxyacetic acid or MCPA; 4-(4-chloro-2-methylphenoxy)butyric acid or MCPB; methylchlorophenoxypropionic acid or MCPP; dichlorprop or 2,4-DP; 2,4-Dichlorophenoxyacetic acid or 2,4 D; and 2,4-Dichlorophenoxybutyric acid or 2,4-DP), quinolinecarboxylic acids (such as quinclorac and quinmerac), benazolin-ethyl, or esters thereof.

Examples of nitrile herbicides include bromoxynil, ioxynil, and bromofenoxim.

Examples of nitrile herbicide esters include xynil esters such as bromoxynil octanoate and ioxynil octanoate.

An example of aminopyridine herbicides includes halauxifen-methyl.

Examples of triazolinone herbicides include sulfentrazone, azafenidin, bencarbazone, and carfentrazone-ethyl.

Examples of chloroacetamide herbicides include acetochlor, alachlor, butachlor, dimetachlor, dimethenamid, meazachlor, metolachlor, pethoxamid, pretilachlor, propachlor, propisochlor, and thenylchlor.

Examples of amide herbicides include propanil and pentanochlor.

An example of quinolone herbicides includes cloquintocet-mexyl.

Examples of pyrimidinedione herbicides include saflufenacil, benzfendizone, and butafenacil.

Examples of triazine herbicides include ametryn, atrazine, cyanazine, hexazinone, prometon, prometryn, propazine, simazine, simetryn, terbuthylazine, and terbutryn.

In particular embodiments, the one or more active ingredients contain one or more insecticides. Non-limitative examples of suitable insecticides include carbamates such as carbaryl and methomyl; organophosphorus insecticides such as malathion, methyl parathion, acephate, dimethoate, fonofos, parathion, chlorpyrifos, and diazinon; pyrethroids such as cypermethrin, bifenthrin, permethrin, tefluthrin, bioresmethrin, resmethrin, allethrin, cyfluthrin, and deltamethrin; nicotinoids such as imidaclodrid; pyrazoles such as fipronil; and organochlorines such as endosulfan.

In particular embodiments, the one or more active ingredients contain one or more fungicides. Non-limitative examples of suitable fungicides include antibiotic fungicides such as azoxystrobin and kresoxim-methyl; dithiocarbamates such as maneb and mancozeb; aliphatic nitrogen fungicides; amides; aromatic fungicides; benzimidazoles; benzimidazole precursors; carbamates; dicarboximides; dinitrophenols; thiocarbamates; dithiocarbamates; ureas; pyrimidines; quinolines; quinones; quinoxalines; various unclassified fungicides such as fenpropidin and piperalin; morpholines such as fenpropimorph and tridemorph; conazoles such as flusilazole, propiconazole, tebuconazole, and triadimefon; pyridines such as pyrifenox; thiazoles such as etridiazole; organophosphorous compounds such as phosdiphen; and imidazoles such as pefurazoate.

The compositions described herein can be used as emulsifiable concentrates, therefore they may be blended with water to form an emulsion. The emulsion forms a vehicle for the active ingredient to contact plant surfaces (e.g. from crops or weeds) to deliver the active ingredient efficiently. Whereas the composition may be blended with water, the composition as such (i.e. before blending with water) typically contains less than 5 wt % water, alternatively less than 2 wt % water, or even less than 1 wt % water.

In order to facilitate the formation of an emulsion, the compositions described herein may comprise one or more surfactants. Suitable surfactants include non-ionic, anionic, cationic, amphoteric or zwitterionic surfactants.

Suitable non-ionic surfactants include, but are not limited to, polyethylene glycol surfactants, polyhydric alcohol surfactants, acetylene surfactants, alkyl glycosides, alkyl phenol ethoxylates, alcohol ethoxylates, sorbitan esters, alkyl polyglycosides, organosilicone surfactants, and other non-ionic surfactants customarily used in the agricultural chemical technology that are known to the person skilled in the art.

Suitable anionic surfactants include, but are not limited to, carboxylic acid surfactants and their salts, sulfate surfactants and their salts, sulfonic acid surfactants and their salts, phosphate surfactants and their salts, and other anionic surfactants customarily used in the agricultural chemical technology that are known to the person skilled in the art.

Suitable cationic surfactants include, but are not limited to, alkyl amine salts, alkyl quaternary ammonium salts, and other cationic surfactants customarily used in the agricultural chemical technology that are known to the person skilled in the art.

Other suitable surfactants include, but are not limited to, amphoteric surfactants such as betaine and amino acid surfactants, zwitterionic surfactants, silicone surfactants, and fluorochemical surfactants.

Although the function of an individual surfactant is dependent on the specific pesticide emulsion in which it is used, typical functions of some non-ionic surfactants are as follows. The ethoxylated nonionic surfactants can function as primary emulsifiers. The sorbitan esters (not ethoxylated) can function as both coupling agents and secondary emulsifiers. The alkyl polyglycosides can function as compatibility agents for high electrolyte tank mixes. The organosilicones can be used as superspreading surfactants.

Typical functions of anionic surfactants include, but are not limited to, acting as secondary emulsifiers, as compatibility agents for high electrolyte tank mixes, and as acidifying agents to reduce the pH of the spray mixes.

In addition to the active ingredient(s), solvent(s), and optional surfactant(s), the compositions provided herein may further comprise one or more additives or adjuvants such as a defoamer (e.g. dimethylsiloxane or polydimethylsiloxane), stabilizer (e.g. UV absorbents, free radical scavengers, and anti-oxidants), thickener, corrosion inhibitor, activator, wetting agent, colorant, humectant, preservative (e.g. bactericide), anti-freeze agent, sticker or adhesive (e.g. polyvinyl alcohols, polyvinyl acetates, or polyacrylates), and the like. Some of these additives may already be present in the compositions provided herein, or may be added afterwards upon or after blending with water.

As described above, the compositions provided herein comprise one or more active ingredients, one or more solvents, and optionally one or more surfactants. Suitable relative amounts of the various components may depend on the type of active ingredient and the desired application, and can be determined by the skilled person without undue burden.

In particular embodiments, the agrochemical compositions described herein comprise:
5 to 80 wt % of the one or more active ingredients;
5 to 95 wt % of one or more solvents, wherein at least 50 wt % of all solvent consists of the aromatic solvent as described above;
0 to 20 wt % of the one or more surfactants; and
0 to 20 wt % additives.

In particular embodiments, the composition comprises less than 10 wt % additives, or even less than 5 wt % additives.

In particular embodiments, the active ingredient(s), solvent(s) (including optional co-solvents), and surfactant(s) together may form more than 80 wt %, more than 90 wt %, or more than 95 wt % of the composition.

As described above, the one or more solvents contained in the composition may contain one or more other solvents (co-solvents) than the aromatic solvent, provided that the aromatic solvent constitutes 50 wt % or more of all solvent present in the composition. In preferred embodiments, at least 60 wt %, at least 75 wt %, at least 95 wt %, or at least 99 wt % of the solvents consist of the aromatic solvent. More particularly, in certain embodiments, the compositions described herein comprise:
5 to 80 wt % of the one or more active ingredients;
5 to 95 wt % of the aromatic solvent as described above;
0 to 50 wt % of one or more co-solvents, provided that the amount of co-solvent in the composition is lower than the amount of the aromatic solvent;
0 to 20 wt % of the one or more surfactants; and
0 to 20 wt % additives.

In particular embodiments, the agrochemical compositions described herein comprise:
5 to 70 wt % of the one or more active ingredients;
10 to 95 wt % of the aromatic solvent as described above;
0 to 25 wt % of one or more co-solvents, provided that the amount of co-solvent in the composition is lower than the amount of the aromatic solvent;
0 to 10 wt % of the one or more surfactants; and
0 to 10 wt % additives.

In such embodiments, the active ingredient(s); the aromatic solvent; optional co-solvents; and surfactant(s) together preferably constitute at least 90 wt % of the composition.

In embodiments where one or more surfactants are present in the composition described herein, the composition typically comprises 1 wt % to 20 wt % of surfactant(s), alternatively 3 wt % to 15 wt %, or alternatively 4 wt % to 10 wt %. In particular embodiments, the agrochemical compositions described herein comprise:
5 to 70 wt % of said one or more active ingredients;
20 to 94 wt % of the aromatic solvent;
0 to 10 wt % of other solvents
1 to 10 wt % of said one or more surfactants; and
0 to 5 wt % additives.

In such embodiments, the active ingredient(s); the aromatic solvent; and surfactant(s) preferably constitute at least 95 wt % of the composition.

The aromatic solvent used in the compositions described herein provides a good solubility for a variety of active ingredients useful in agriculture. Accordingly, further provided herein is the use of the aromatic solvent as a solvent for an organic agriculturally active ingredient. The details regarding the solvent and active ingredient set out above with regard to the composition, equally apply to the uses provided herein.

### Emulsion

As described above, the compositions described herein may be diluted and blended with water to form an emulsion. Accordingly, further provided herein is an emulsion comprising the agrochemical composition as described herein, and water. In particular embodiments, the emulsion may be prepared by blending the agrochemical composition with water in an agrochemical composition:water ratio ranging from 1:5 to 1:5000.

Further described herein is a method for protecting a crop, more particularly for protecting a crop from one or more pests, comprising blending an agrochemical composition as described herein with water to form an emulsion; and applying said emulsion to the crop.

Further disclosed are the following embodiments of the compositions and use described herein: Embodiment 1. An agrochemical composition comprising:
one or more active ingredients;
an aromatic solvent comprising at least 50 wt % of one or more compounds selected from compounds of formula (A) and (B):

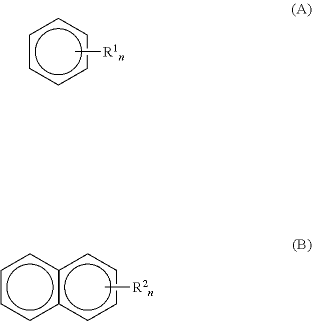

wherein n is an integer ranging from 2 to 5; and m is an integer ranging from 1 to 5; each R¹ and each R² is independently a linear or branched C₁-C₁₆alkyl; provided that in compounds of formula (A) at least one R¹ is C₄-C₁₆alkyl; and in compounds of formula (B) at least one R² is C₄-C₁₆alkyl;
   and
optionally, one or more surfactants.

Embodiment 2. The agrochemical composition of embodiment 1, wherein the aromatic solvent comprises at least 60 wt % of one or more compounds selected from compounds of formula (A) and (B).

Embodiment 3. The agrochemical composition of embodiment 1, wherein the aromatic solvent comprises at least 75 wt % of one or more compounds selected from compounds of formula (A) and (B).

Embodiment 4. The agrochemical composition of any one of embodiments 1 to 3, wherein each R¹ and each R² is independently a linear or branched C₁-C₁₀alkyl, wherein in compounds of formula (A) at least one R¹ is C₄-C₁₀alkyl; and in compounds of formula (B) at least one R² is C₄-C₁₀alkyl.

Embodiment 5. The agrochemical composition of any one of embodiments 1 to 3, wherein each R¹ and each R² is independently a linear or branched C₁-C₈alkyl, wherein in compounds of formula (A) at least one R¹ is C₄-C₈alkyl; and in compounds of formula (B) at least one R² is C₄-C₈alkyl.

Embodiment 6. The agrochemical composition of any one of embodiments 1 to 5, wherein R¹ and R² are linear alkyl.

Embodiment 7. The agrochemical composition of any one of embodiments 1 to 6, wherein 5 to 15 wt % of said aromatic solvent consists of compounds selected from compounds of formula (A) containing at least two R¹ groups having at least 4 carbon atoms, and compounds of formula (B) containing at least two R² groups having at least 4 carbon atoms.

Embodiment 8. The agrochemical composition according to any one of embodiments 1 to 7, wherein said aromatic solvent has an aromatic content of at least 95 wt %.

Embodiment 9. The agrochemical composition according to any one of embodiments 1 to 8, wherein said aromatic solvent may further contain one or more compounds selected from compounds of formula (C) and (D):

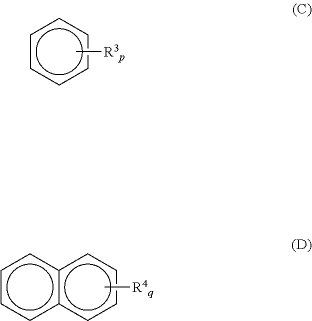

wherein p and q independently are an integer ranging from 0 to 5; R³ is a linear or branched C₁-C₁₆alkyl if p is 1, each R³ is independently a C₁-C₃alkyl if p is 2 to 5; each R⁴ is independently a C₁-C₃alkyl; and wherein said aromatic solvent comprises at least 90 wt % of compounds selected from compounds of formula (A), (B), (C), and (D).

Embodiment 10. The agrochemical composition of embodiment 9, wherein said aromatic solvent comprises at least 95 wt % of compounds selected from compounds of formula (A), (B), (C), and (D).

Embodiment 11. The agrochemical composition of embodiment 9 or 10, wherein said aromatic solvent comprises at least 90 wt % of compounds selected from compounds of formula (B) and (D).

Embodiment 12. The agrochemical composition of any one of embodiments 9 to 11, wherein p and q independently are an integer ranging from 1 to 5; preferably p is 1 to 3 and q is 1 to 4.

Embodiment 13. The agrochemical composition of any one of embodiments 1 to 12, comprising: 5 to 80 wt % of said one or more active ingredients; 5 to 95 wt % of said aromatic solvent; and 0 to 20 wt % of said one or more surfactants.

Embodiment 14. The agrochemical composition of embodiment 13, wherein said one or more active ingredients, said aromatic solvent, and said one or more surfactants form at least 60 wt % of said agrochemical composition.

Embodiment 15. The agrochemical composition of embodiment 13, wherein said one or more active ingredients, said aromatic solvent, and said one or more surfactants form at least 80 wt % of said agrochemical composition.

Embodiment 16. The agrochemical composition of any one of embodiments 1 to 15, wherein said aromatic solvent has one or more of the following properties:
a kinematic viscosity at 25° C. between 5 mm²/s and 25 mm²/s as measured according to ASTM D7042;
a density ranging from 0.95 to 1.00, as measured at 25° C. according to ISO 12185;
a pour point below −40° C., as measured according to ASTM D5950;
a naphthalene content below 1.0 wt % as measured according to ASTM D5769; and
a total 1-methylnaphthalene and 2-methylnaphthalene content below 10 wt % as measured according to ASTM D5769.

Embodiment 17. The agrochemical composition of any one of embodiments 1 to 16, wherein the aromatic solvent comprises at least 50 wt % of compounds of formula (B), and optionally at least 5 wt % of compounds of formula (A).

Embodiment 18. The agrochemical composition of any one of embodiments 1 to 17, wherein said one or more active ingredients are pesticides selected from the list consisting of herbicides, insecticides, fungicides, acaricides, nematicides, miticides, rodenticides, bactericides, molluscicides, bird repellents, and combinations thereof.

Embodiment 19. The agrochemical composition of any one of embodiments 1 to 18, wherein said one or more active ingredients include one or more herbicides selected from a dinitroaniline type herbicide, a synthetic auxin, a nitrile herbicide, and derivatives thereof.

Embodiment 20. The agrochemical composition of embodiment 19, wherein said synthetic auxin is a pyridine-carboxylic acid.

Embodiment 21. The agrochemical composition of any one of embodiments 1 to 20, wherein said aromatic solvent comprises at least 50 wt % C₁₄₊ aromatics.

Embodiment 22. The agrochemical composition of any one of embodiments 1 to 21, wherein said aromatic solvent comprises less than 10 wppm sulfur.

Embodiment 23. The agrochemical composition of any one of embodiments 1 to 22, comprising at least 1.0 wt % of one or more surfactants selected from a cationic surfactant, an anionic surfactant, and a non-ionic surfactant.

Embodiment 24. An emulsion comprising the agrochemical composition of any one of embodiments 1 to 23, and water.

Embodiment 25. The use of an aromatic solvent comprising at least 50 wt % of one or more compounds selected from compounds of formula (A) and (B)

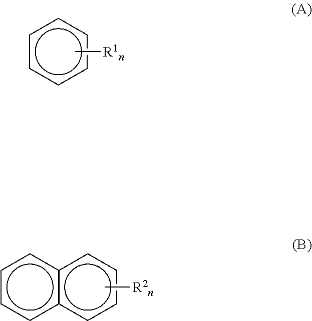

wherein n and m independently are an integer ranging from 1 to 5; each R¹ and each R² is independently a linear or branched C₁-C₁₆alkyl; provided that in compounds of formula (A) at least one R¹ is C₄-C₁₆alkyl; and in compounds of formula (B) at least one R² is C₄-C₁₆alkyl; as a solvent for an organic agrochemical.

### Examples

The following examples are provided for the purpose of illustrating the present invention and by no means are meant and in no way should be interpreted to limit the scope of the present invention.

### Synthesis of Butylated Aromatics

Butylated aromatic solvents were prepared starting from five different aromatic solvents or compounds: (i) Aromatic 200ND fluid, (ii) Aromatic 200 fluid, (iii) naphthalene, (iv) naphthalene heartcut, and (v) MTPX bottoms. Aromatic 200 and Aromatic 200ND fluid are available from ExxonMobil Chemical. The naphthalene heartcut is a naphthalene-rich side product obtained in the production of naphthalene depleted aromatic fluids. MTPX bottoms are a side product obtained in the alkylation of toluene to form para-xylene, mainly containing toluene-derived Cioaromatics.

For each of solvents (i)-(v), a mixture of aromatic solvent and 2-6 wt % zeolite catalyst was loaded into an autoclave, purged with nitrogen and subsequently pressurized with butene (mix of trans-2-butene, cis-2-butene, and 1-butene; 1-3 mole equivalents relative to the aromatic compounds). The reaction mixture was subsequently heated to 200° C. After a desired reaction time (up to 24 hours), the reaction mixture was cooled to room temperature and ventilated to remove excess butene. The catalyst was removed by filtration and low-boiling unreacted starting materials were removed via Kugelrohr distillation at 0.13 kPa (1 Torr) and 80° C. (for Example E3) or 90° C. (for Examples E1, E2, E4, and E5), yielding a butylated aromatic solvent containing predominantly mono- and di-butylated aromatic compounds, as determined via GC and GC-MS analysis. The Examples E1-E5 and comparative examples C1 and C2 (unreacted Aromatic 200 and Aromatic 200ND fluid) are summarized in Table 1. The table also provides the distillation temperature used to remove unreacted aromatic solvent via Kugelrohr distillation at 0.13 kPa (1 Torr).

TABLE 1
List of solvents

| Example | Description |
|---|---|
| E1 | Butylated Aromatic 200ND fluid |
| E2 | Butylated Aromatic 200 fluid |
| E3 | Butylated naphthalene |
| E4 | Butylated naphthalene heartcut |
| E5 | Butylated MTPX bottoms |
| C1 | Aromatic 200 fluid |
| C2 | Aromatic 200ND fluid |

### Physical Property Characterization of Aromatic Solvents

Various properties of the solvents were tested, and compared to non-butylated Aromatic 200 and Aromatic 200ND fluid as reference. The following properties of the solvents were tested:
Kinematic viscosity at 25° C. (KV25) was determined based on the method described in ASTM D7042.
Density at 25° C. was determined based on the method described in ASTM D4052.
Pour point was determined according to ASTM D5950.
Naphthalene, 1-methylnaphthalene, and 2-methylnaphthalene content was determined according to ASTM D5769. For 1-methylnaphthalene and 2-methylnaphthalene, the standard IUPAC naphthalene carbon atom numbering is used.

The results are provided in Table 2.

TABLE 2
Physical properties of solvents

| | | Density | Pour | Naphthalene | | |
|---|---|---|---|---|---|---|
| | KV25 | at 25° C. | Point | content | 1-methylnapthalene | 2-methylaphthalene |
| Solvent | (cSt) | (g/mL) | (° C.) | (ppm w/w) | content (wt %) | content (wt %) |
| E1 | 9.86 | 0.9649 | −56 | 882 | 2.150 | 4.391 |
| E2 | 13.08 | 0.9598 | −54 | 1013 | 0.867 | 2.962 |
| E3 | 6.80 | 0.9703 | −65 | 25696 | 0.033 | 0.003 |
| E4 | 24.85 | 0.9573 | −46 | 1664 | 2.828 | 6.819 |
| E5 | 8.35 | 0.9332 | −65 | 6369 | 0.042 | 0.011 |
| C1 | 2.694 | 0.9870 | −30 | 33244 | 13.625 | 25.962 |
| C2 | 2.86 | 0.9920 | −36 | 1000 | 14.701 | 27.729 |

From Table 2, it can be seen that all solvents have a KV25 below 25 cSt, and most have a KV25 below 15 cSt. In general, high viscosities are less preferred in emulsifiable concentrates, since this can lower the maximal loading of active ingredients. Comparing solvents E2 and C1, it can be seen that butylation increases KV25, but to an acceptable extent. All solvents are considered having a suitable viscosity.

The solvents also have densities at 25° C. which are relatively close to water. Densities close to that of water are preferred, as this improves the emulsion stability when the solvent and active ingredient are mixed with water. Indeed, if the solvent density is too low or too high compared to that of water, an emulsion of the solvent in water can have a higher tendency to separate.

Solvents E1-E5 have a very low pour point (below −45° C.), comparing favorably to comparative solvents C1 and C2. A low pour point of the solvent allows for pesticide application under cold conditions.

Table 2 further shows that the butylated solvents contain relatively low concentrations of naphthalene, 1-methylnaphthalene, and 2-methylnaphthalene. From environmental considerations, low concentrations of these compounds are preferred.

### Solvency Tests

Solvency of solvents E1-E5 and C1-C2 was tested by dissolving various solid active ingredients in each solvent. The following pesticides were tested as active ingredients: trifluralin, fluroxypyr, and bromoxynil octanoate.

Solvency was characterized by the weight ratio of an active ingredient in a solvent and was determined by adding 0.5 gram of active ingredient to a vial equipped with a stir bar and then charging the solvent to achieve a desired concentration. The vials were capped and placed into a water bath kept at a temperature 5 to 10° C. below the melting point of tested pesticide. The mixture was stirred in the vial for 24 hours. If the active ingredient was fully dissolved, the mixture was transferred to a room temperature water bath. If no active ingredient crystals were formed, a higher concentration of active ingredient was tested. Conversely, if active ingredient crystals were formed, a lower concentration of active ingredient was tested. Solubility was recorded as the highest concentration of active ingredient in the tested solvent with no formation of crystals. Concentrations were tested at a 5% interval. For example, if the active ingredient was dissolved at 50%, 55% would be the next concentration to be tested. Concentrations below 15 wt % were not tested. Each test was replicated and the results were reported as an average. The test results are provided in Table 3.

From Table 3, it can be seen that solvents E1-E5 generally provide a good to excellent solvency for trifluralin, and bromoxynil octanoate, comparable to the solvency provided by aromatic solvents C1 and C2. Solvency for fluroxypyr was generally lower compared to aromatic solvents C1 and C2, but still sufficient. It is noted that the fluroxypyr solvency test for E1 at 15 wt % only resulted in a small amount of crystals, therefore solvency is below, but close to 15 wt %. In view of these results, it can be concluded that butylated solvents E1-E5 provide a good alternative for aromatic solvents such as solvents C1 and C2.

TABLE 3
Solvency test results (results in wt % active ingredient in solution)

| Solvent | Trifluralin | Fluroxypyr | Bromoxynil Octanoate |
|---|---|---|---|
| E1 | 65 | <15 | 66 |
| E2 | 64 | 27 | 71 |
| E3 | 65 | 16 | 72 |
| E4 | 67 | 53 | 72 |
| E5 | 67 | 16 | 69 |
| C1 | 68 | 57 | 71 |
| C2 | 66 | 59 | 69 |

Any alterations, modifications, and variations will be apparent to those skilled in the art in light of the foregoing description without departing from the spirit or scope of the present disclosure and that when numerical lower limits and numerical upper limits are listed herein, ranges from any lower limit to any upper limit are contemplated.

1. An agrochemical composition comprising:
one or more active ingredients;
an aromatic solvent comprising at least 50 wt % of one or more compounds selected from compounds of formula (A) and (B): 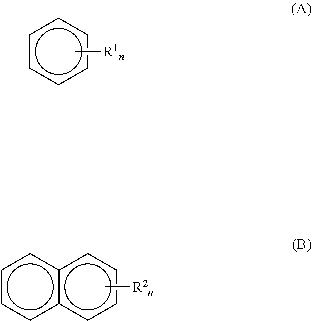
wherein n is an integer ranging from 2 to 5; and m is an integer ranging from 1 to 5;
each R¹ and each R² is independently a linear or branched C₁-C₁₆alkyl; provided that in compounds of formula (A) at least one R¹ is C₄-C₁₆alkyl; and in compounds of formula (B) at least one R² is C₄-C₁₆alkyl;
and
optionally, one or more surfactants.

2. The agrochemical composition of claim 1, wherein the aromatic solvent comprises at least 60 wt % of one or more compounds selected from compounds of formula (A) and (B), preferably at least 75 wt %.

3. The agrochemical composition of claim 1, wherein each R¹ and each R² is independently a linear or branched C₁-C₁₀alkyl, wherein:
in compounds of formula (A) at least one R¹ is C₄-C₁₀alkyl; and
in compounds of formula (B) at least one R² is C₄-C₁₀alkyl.

4. The agrochemical composition of claim 1, wherein R¹ and R² are linear alkyl.

5. The agrochemical composition according to claim 1, wherein said aromatic solvent has an aromatic content of at least 95 wt %.

6. The agrochemical composition according to claim 1, wherein said aromatic solvent further contains one or more compounds selected from compounds of formula (C) and (D): 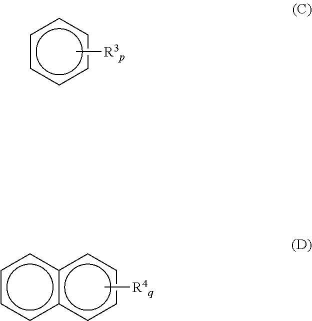
wherein p and q independently are an integer ranging from 0 to 5;
R³ is a linear or branched C₁-C₁₆alkyl if p is 1, and each R³ is independently a C₁-C₃alkyl if p is 2 to 5; each R⁴ is independently a C₁-C₃alkyl; and
wherein said aromatic solvent comprises at least 90 wt % of compounds selected from compounds of formula (A), (B), (C), and (D).

7. The agrochemical composition of claim 6, wherein p and q independently are an integer ranging from 1 to 5.

8. The agrochemical composition of claim 1, comprising:
5 to 80 wt % of said one or more active ingredients;
5 to 95 wt % of said aromatic solvent; and
0 to 20 wt % of said one or more surfactants.

9. The agrochemical composition of claim 8, wherein said one or more active ingredients, said aromatic solvent, and said one or more surfactants form at least 60 wt % of said agrochemical composition.

10. The agrochemical composition of claim 1, wherein said aromatic solvent has one or more of the following properties:
a kinematic viscosity at 25° C. between 5 mm²/s and 25 mm²/s as measured according to ASTM D7042;
a density ranging from 0.95 to 1.00, as measured at 25° C. according to ISO 12185;
a pour point below −40° C., as measured according to ASTM D5950;
a naphthalene content below 1.0 wt % as measured according to ASTM D5769; and
a total 1-methylnaphthalene and 2-methylnaphthalene content below 10 wt % as measured according to ASTM D5769.

11. The agrochemical composition of claim 1, wherein the aromatic solvent comprises at least 50 wt % of compounds of formula (B), and optionally at least 5 wt % of compounds of formula (A).

12. The agrochemical composition of claim 1, wherein said one or more active ingredients are pesticides selected from the list consisting of herbicides, insecticides, fungicides, acaricides, nematicides, miticides, rodenticides, bactericides, molluscicides, bird repellents, and combinations thereof.

13. The agrochemical composition of claim 1, wherein said one or more active ingredients include one or more herbicides selected from a dinitroaniline type herbicide, a synthetic auxin, a nitrile herbicide, and derivatives thereof.

14. An emulsion comprising the agrochemical composition of claim 1, and water.

15. The use of an aromatic solvent comprising at least 50 wt % of one or more compounds selected from compounds of formula (A) and (B) 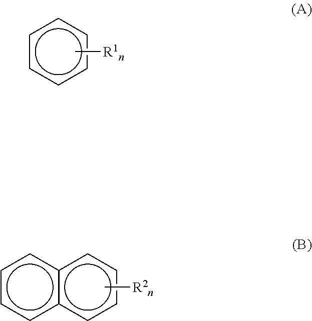
wherein n and m independently are an integer ranging from 1 to 5;
each R¹ and each R² is independently a linear or branched C₁-C₁₆alkyl; provided that in compounds of formula (A) at least one R¹ is C₄-C₁₆alkyl; and in compounds of formula (B) at least one R² is C₄-C₁₆alkyl;
as a solvent for an organic agrochemical.
